(19) United States
(12) Patent Application Publication
(10) Pub. No.: US 2011/0134463 A1
(43) Pub. Date: Jun. 9, 2011

(54) Control point, image forming apparatus, and printing control method

(75) Inventors: Jae-in Lee, Suwon-si (KR); Dae-hyun Kim, Yongin-si (KR)

(73) Assignee: SAMSUNG ELECTRONICS CO., LTD., Suwon-si (KR)

(21) Appl. No.: 12/801,633

(22) Filed: Jun. 17, 2010

(30) Foreign Application Priority Data
Dec. 3, 2009 (KR) 2009-0118995

(51) Int. Cl. G06F 3/12

(52) U.S. Cl. 358/1.15

(57) ABSTRACT

A control point including a user interface through which at least one file for printing is selected, a communication interface which searches for at least one image forming apparatus using DLNA, a DLNA stack unit which receives device information corresponding to the searched at least one image forming apparatus, an image processor which converts the file for printing to correspond to the image forming apparatus using the device information, a printing job generator which generates printing data regarding the converted file for printing, and a controller which controls the communication interface to transmit the generated printing data to the image forming apparatus.

### CROSS-REFERENCE TO RELATED APPLICATIONS

This application claims priority under 35 U.S.C. §119 from Korean Patent Application No. 10-2009-118995, filed on Dec. 3, 2009, in the Korean Intellectual Property Office, the disclosure of which is incorporated herein by reference in its entirety.

### BACKGROUND

1. Field

The present invention relates to a control point, an image forming apparatus, and a printing control method, and more particularly, to a control point, an image forming apparatus, and a printing control method, which convert image data commanded to be printed, thereby mitigating a network transmission load.

2. Description of the Related Art

In general, an image forming apparatus refers to an apparatus which prints printing data generated by a terminal device such as a computer on a recording medium. Examples of such an image forming apparatus may be a copier, a printer, a facsimile machine and a multifunction peripheral (MFP) which incorporates the functions of the aforementioned devices in a single device.

A recently widespread image forming apparatus supports the digital living network alliance (DLNA) standard and thus receives a printing job from diverse DLNA devices as well as a terminal device such as a computer.

The DLNA, which is an organization for standardization of a digital information technology product, was established to provide a standard to allow data such as music, pictures, and moving pictures to be shared among devices. The DLNA aims to establish a mutually compatible platform based on a standard already published in the industry and achieve convergence among the industries. The DLNA promotes introduction of a guideline for the manufacturers of household appliances, personal computers, and wireless devices based on the Universal Plug and Play (UPnP) protocols which are being widely used by these manufacturers.

Accordingly, users can enjoy diverse contents within a DLNA network using a DLNA device, and can output a desired content through an image forming apparatus connected to the DLNA network.

However, under a conventional DLNA environment, original data is transmitted along with Extensible Hypertext Markup Language (XHML)-Print data corresponding to a value set in a DLNA device. Therefore, the size of original data being transmitted is larger than the size when it is output. In this case, unnecessary data may be transmitted to the image forming apparatus and the load on the network increases accordingly.

### SUMMARY

Exemplary embodiments address at least the above problems and/or disadvantages and other disadvantages not described above. Also, the present exemplary embodiments are not required to overcome the disadvantages described above, and an exemplary embodiment may not overcome any of the problems described above.

Additional aspects and/or advantages will be set forth in part in the description which follows and, in part, will be apparent from the description, or may be learned by practice of the invention.

The present embodiments provide a control point, an image forming apparatus, and a printing control method, which convert image data commanded to be printed, thereby mitigating a network transmission load.

According to an exemplary aspect, there is provided a control point which is connected to at least one image forming apparatus under a digital living network alliance (DLNA) environment, the control point including: a user interface through which at least one file for printing is selected, a communication interface which searches for at least one image forming apparatus using DLNA, a DLNA stack unit which receives device information corresponding to the searched at least one image forming apparatus, an image processor which converts the file for printing to correspond to the image forming apparatus using the device information, a printing job generator which generates printing data regarding the converted file for printing, and a controller which controls the communication interface to transmit the generated printing data to the image forming apparatus.

The device information may include at least one of a current status, a resolution, a paper size, and information regarding ability/disability to perform a color printing operation of the image forming apparatus.

The file for printing may be at least one of an image file and a document file.

The user interface may display a list of the searched at least one image forming apparatus and receive selection of at least one image forming apparatus from the list, and the communication interface may request the selected image forming apparatus to transmit device information.

The printing job generator may generate printing data by applying a printing option which is input through the user interface.

The image processor may include a calculator which calculates a reduction ratio of the file for printing using the selected printing option, and a converter which reduces an image size of the file for printing according to the calculated reduction ratio.

The image processor may reduce or enlarge the file for printing according to the device information.

The image processor may convert the file for printing into a monochrome or color image according to the device information.

The image processor may convert a file attribute of the file for printing so as to reduce a data size of the file for printing.

The user interface may receive selection of at least one template from pre-stored plural templates, and the image processor may reduce an image size of the file for printing using size information of the selected template.

The control point may further include a storage unit which stores the converted file for printing, and the printing job generator may change an address of the file for printing within the generated printing data to an address of the converted file for printing.

According to another exemplary aspect, there is provided an image forming apparatus which is connected to at least one control point under a DLNA environment, the image forming apparatus including: a DLNA stack unit which generates device information of the image forming apparatus if a request for device information is received from the control point, a communication interface which transmits the generated device information to the control point, and an image forming unit which receives printing data corresponding to the generated device information and a file for printing through the communication interface, and prints the file for printing based on the printing data. The device information may include at least one of a current status, a resolution, a paper size, and information regarding ability/disability to perform a color printing operation of the image forming apparatus.

According to another exemplary aspect, there is provided a printing control method of a control point which is connected to at least one image forming apparatus under a DLNA environment, the method including: selecting at least one file for printing through a user interface of the control point, searching for at least one image forming apparatus using DLNA, receiving device information corresponding to the searched at least one image forming apparatus, converting the file for printing to correspond to the image forming apparatus using the received device information, generating printing data regarding the converted file for printing, and transmitting the generated printing data to the image forming apparatus.

The device information may include at least one of a current status, a resolution, a paper size, and information regarding ability/disability to perform a color printing operation of the image forming apparatus.

The file for printing may be at least one of an image file and a document file.

The method may further include displaying a list of the searched at least one image forming apparatus, and selecting at least one image forming apparatus from the searched at least one image forming apparatus and requesting the selected image forming apparatus to transmit device information.

The operation of generating the printing data may generate the printing data by applying a printing option which is input through the user interface.

The operation of converting the file for printing may include calculating a reduction ratio of the file for printing using the selected printing option, and reducing an image size of the file for printing according to the calculated reduction ratio.

The operation of converting the file for printing may reduce or enlarge the file for printing according to the device information.

The operation of converting the file for printing may convert the file for printing into a monochrome or color image according to the device information.

The operation of converting the file for printing may convert a file attribute of the file for printing so as to reduce a data size of the file for printing.

The method may further include selecting at least one template from pre-stored plural templates, and the operation of converting the file for printing may reduce an image size of the file for printing using size information of the selected template.

The method may further include storing the converted file for printing, and changing an address of the file for printing within the generated printing data to an address of the converted file for printing.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram illustrating a printing control system according to an exemplary embodiment of the present invention;

FIG. 2 is a view illustrating an example of a template;

FIG. 3 is a view provided to explain an operation of a calculator of FIG. 1;

FIGS. 4A and 4B are views illustrating an example of printing data generated according to an exemplary embodiment of the present invention; and

FIG. 5 is a flowchart illustrating a printing control method according to an exemplary embodiment of the present invention.

### DETAILED DESCRIPTION

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. However, the present invention can be carried out without those specifically defined matters. Also, well-known functions or constructions are not described in detail since they would obscure the invention with unnecessary detail.

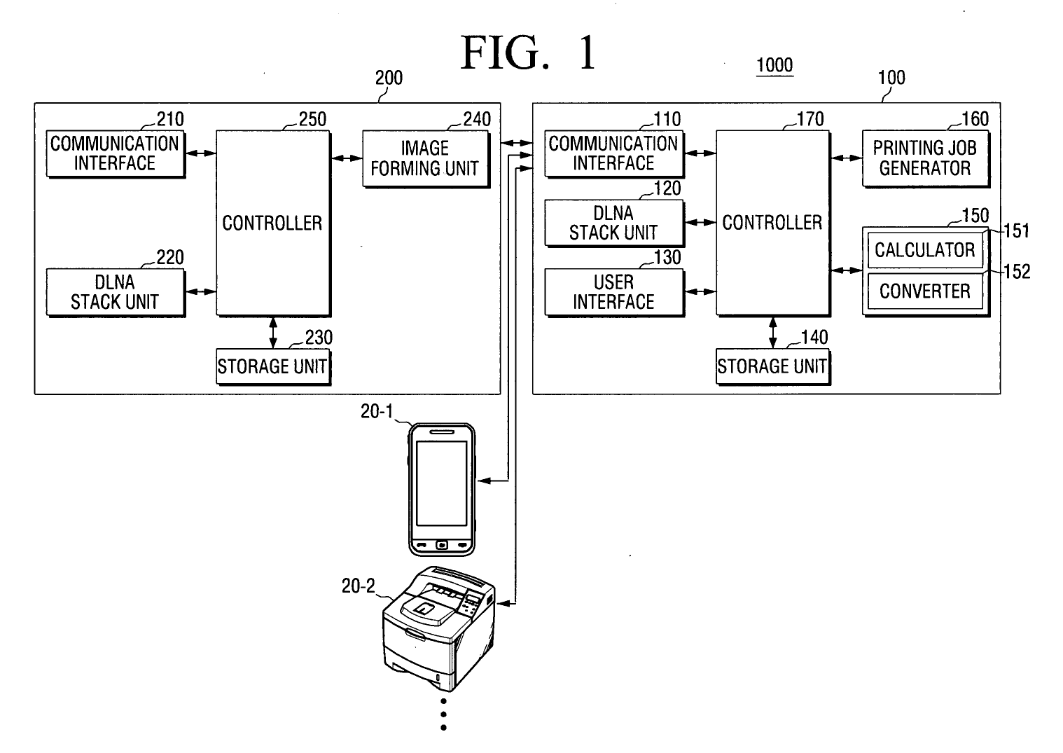

FIG. 1 is a block diagram illustrating a printing control system according to an exemplary embodiment of the present invention.

Referring to FIG. 1, a printing control system 1000 includes a control point 100 and an image forming apparatus 200.

The control point 100 receives device information from at least one image forming apparatus 200, converts a file for printing according to the received device information, generates printing data regarding the converted file for printing, and transmits the printing data.

The control point 100 recited herein is a DLNA device which can share contents with the other control points 20-1, 20-2, . . . within a DLNA network, and can access a DLNA image forming apparatus within the DLNA network to output a content. For example, the DLNA device may be one of a digital media server (DMS), a digital media player (DMP), and a digital media renderer (DMR), which are prescribed in the DLNA guideline.

The DMS is a device which performs a function of a media server device (MSD) in a UPnP AV area, that is, a function of providing digital media contents, and searches for a digital media content item within the DMS so that a DLNA network user can display or distribute the contents. For example, the DMS may include a videocassette recorder (VCR), a compact (CD) player, a digital versatile disk (DVD) player, an MP3 player, a set-top box, a television (TV) tuner, a radio tuner, and a personal computer (PC).

The DMR executes a selected media and may include a TV, a stereo, and a speaker. Also, the DMP is a DMR including a UPnP control point and performs functions of a media renderer device (MRD) and a media render control point (MRCP), that is, functions of selecting and controlling a media content and executing the selected media.

More specifically, the control point 100 may include a communication interface 110, a DLNA stack unit 120, a user interface 130, a storage unit 140, an image processor 150, a printing job generator 160, and a controller 170.

The communication interface 110 is connected to the DLNA network and shares contents with the other control points 20-1, 20-2, . . . within the DLNA network. More specifically, the communication interface 110 may communicate with the other control points 20-1, 20-2, . . . within the DLNA network according to a UPnP standard to be able to share contents stored in the other control points 20-1, 20-2, . . . .

Also, if a command to print is input by a user, the communication interface 110 may search for image forming apparatuses 200, 20-2 connected to the DLNA network, and may control the user interface 130 to display a list of searched image forming apparatuses 200, 20-2 for the user.

Also, if the user selects the image forming apparatus 200 to perform a printing job, the communication interface 110 may request the image forming apparatus 200 within the DLNA network to perform the printing job according to a DLNA standard and a DLNA printer standard, and may receive a job ID and a URL address regarding the printing job (an address to which printing data is to be transmitted) from the image forming apparatus 200.

The communication interface 110 may transmit printing data which is generated by the printing job generator 160 and a file for printing which is converted by the image processor 150 to the image forming apparatus 200.

The communication interface 110 may receive device information of the image forming apparatus 200 selected by the user. The device information is information regarding the performance of the image forming apparatus 200 and may include a current status of the image forming apparatus 200, a resolution, a paper size, and information regarding ability/disability to perform a color printing operation of the image forming apparatus 200.

The DLNA stack unit 120 may control the communication interface 110 to communicate with a control point or a DLNA image forming apparatus within the DLNA network according to the DLNA standard and the DLNA printer standard. More specifically, the DLNA stack unit 120 may control the communication interface 110 to generate a device description based on a Core protocol which is essentially necessary for the DLNA operation and to request the image forming apparatus 200 within the DLNA network to perform a printing job in a UPnP method. The DLNA stack unit 120 and the communication interface 110 are separate elements in this embodiment. However, the function of the DLNA stack unit 120 and the function of the communication interface 110 may be combined in a single element.

The user interface 130 has a plurality of function keys to allow a user to set or select diverse functions supported by the control point 100, and displays diverse information provided by the control point 100. The user interface 130 may be a device which realizes input and output simultaneously such as a touch pad, or a device which combines a mouse and a monitor. Accordingly, the user selects at least one file for printing through a user interface (UI) window provided by the user interface 130. At this time, the user may select diverse printing options for outputting the file for printing.

Also, the user interface 130 may display the searched image forming apparatuses 200, 20-2. More specifically, the user interface 130 may display a list of image forming apparatuses 200, 20-2, which are searched in the DLNA network through the communication interface 110, and may receive selection of at least one image forming apparatus 200 to perform the printing job.

The user interface 130 may display a plurality of templates in response to a user command to print. More specifically, the user interface 130 may display a plurality of templates which are pre-stored in the storage unit 140, and may allow a user to select one of them. Accordingly, the user can easily select a layout of the file for printing.

The template recited herein is an image which is generated by a user or already set in the image forming apparatus 200 for the purpose of being combined with the file for printing, and may have diverse layouts. Also, texts may be described on the template in the form of a text box.

The storage unit 140 stores the file for printing. More specifically, the storage unit 140 may pre-store diverse files for printing and may store a file for printing which is received through the communication interface 110. Also, the storage unit 140 may store a file for printing which is converted by the image processor 150. The file for printing recited herein may be an image file and a document file of an image format.

The storage unit 140 may pre-store the plurality of templates. The storage unit 140 may be an internal storage medium or an external storage medium of the control point 100, for example, a removable disk including a universal serial bus (USB) memory, a storage medium connected to a host, and a web server connected to a network.

The image processor 150 converts the file for printing. More specifically, the image processor 150 may convert the file for printing to correspond to the image forming apparatus 200 using the device information received through the communication interface 100 and the information of the template and the printing option selected by the user through the user interface 130. The image processor 150 may include a calculator 151 and a converter 152.

The calculator 151 calculates a reduction ratio of the file for printing using the selected printing option. More specifically, the calculator 151 calculates ‘an image size necessary for outputting a file for printing’ using a printing option selected through the user interface 130 in relation to an image size and image quality, and compares the calculated ‘image size necessary for outputting a file for printing’ and the size of the selected file for printing and calculates a reduction ratio.

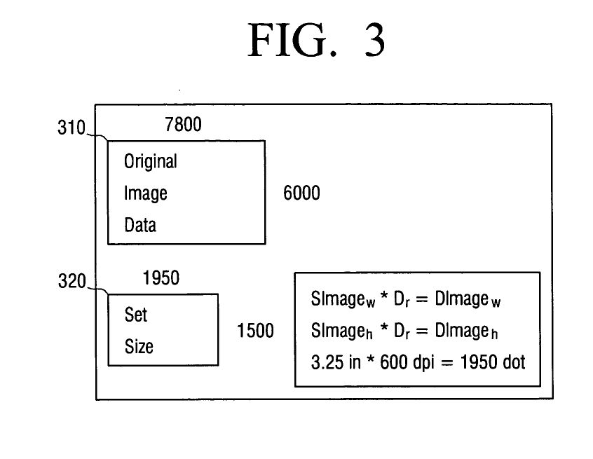

For example, if the image size of the selected file for printing is 7800(dot)*6000(dot) but if the ‘image size necessary for outputting a file for printing’ calculated based on the printing option selected by the user is 1950(dot)*1500(dot) as shown in FIG. 3, 1500/6000=0.25, that is, the reduction ratio of the file for printing is calculated as 25%.

The calculator 151 may calculate the reduction ratio additionally using the device information of the image forming apparatus 200. More specifically, the calculator 151 may calculate an ‘image size necessary for outputting a file for printing’ based on resolution information supported by the image forming apparatus 200 among the device information received through the communication interface 110, and calculate a reduction ratio based on this information.

Also, the calculator 151 may calculate the reduction ratio additionally using the size information of the selected template. More specifically, the calculator 151 may calculate a reduction ratio using information of a size occupied by the file for printing in the template selected by the user through the user interface 130 as the ‘image size necessary for outputting a file for printing’. If the width/height ratio of the template selected by the user is different from the width/height ratio of the file for printing, the calculator 151 may calculate a width reduction ratio and a height reduction ratio separately, and may select one reduction ratio using an algorithm selected or pre-set by the user or may provide information of the width reduction ratio and the height reduction ratio to the converter 152.

The converter 152 may reduce or enlarge the image size of the file for printing according to the calculated reduction ratio. More specifically, the converter 152 may reduce the image size of the selected file for printing using the reduction ratio calculated by the calculator 151. For example, if the reduction ratio calculated by the calculator 151 is 25%, the image size of the original file for printing is reduced by 25%. The image size may be reduced using diverse image processing algorithms. In this embodiment, the image size of the file for printing is reduced. However, the image size of the file for printing may be enlarged.

Also, the converter 152 may convert the file for printing into a monochrome or color image. More specifically, if the selected image forming apparatus does not support color printing or if the user selects a monochrome printing option, the converter 152 may convert the file for printing into a monochrome image.

Also, the converter 152 may convert a file attribute of the file for printing so as to reduce a data size of the file for printing. For example, if the file for printing has a file attribute of ‘bmp’, the converter 152 may convert the file into a ‘jpg’ file which is an example of a compressed image file.

The converter 152 may store the converted file for printing in the storage unit 140. The converter 152 may overwrite the original file with the converted file, and may store the converted file in a pre-set name or a name selected by the user.

The printing job generator 160 generates printing data regarding the file for printing. More specifically, if a command to print is input by a user, the printing job generator 160 may generate XHTML-Print data including an address in which the file for printing selected by the user is stored so as to output the file for printing.

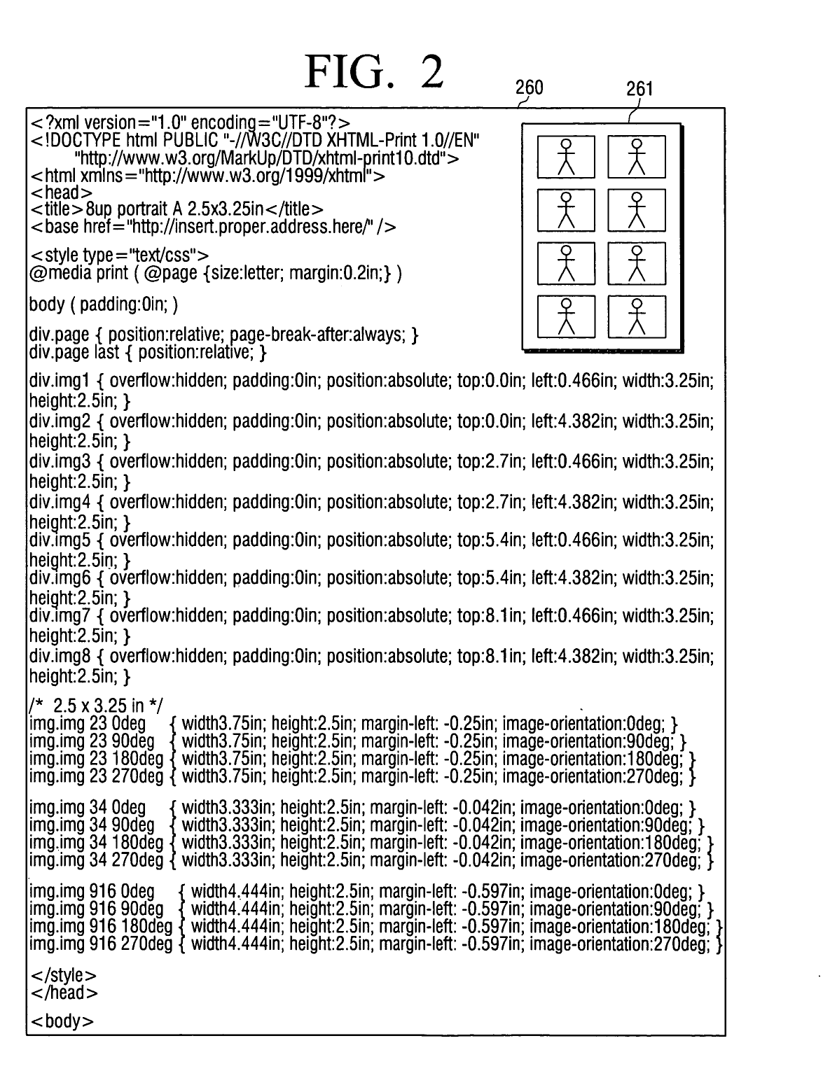

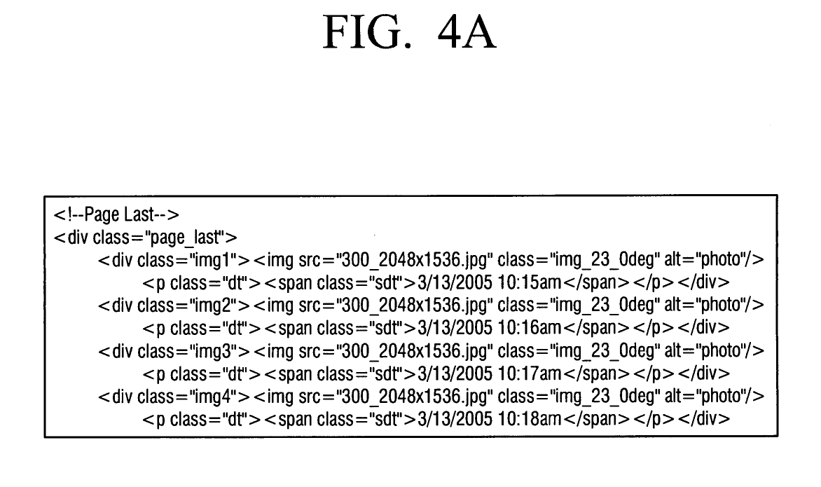

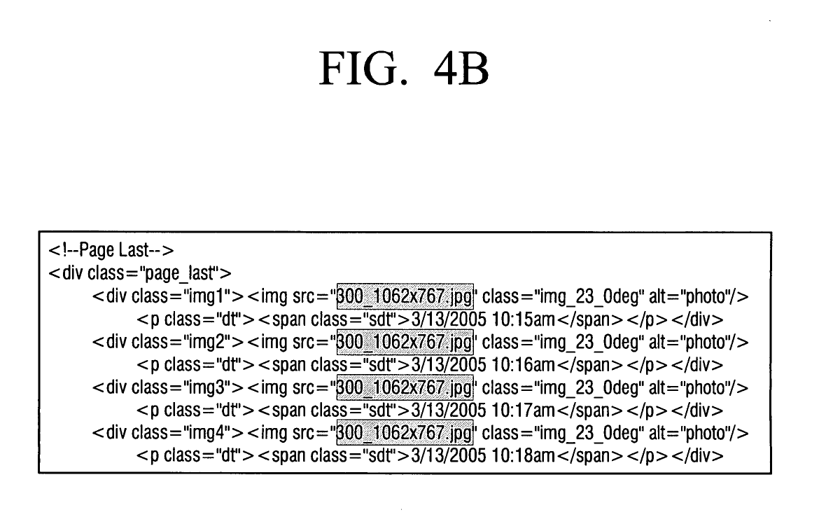

For example, if the user selects a template 260 having a ‘8-up layout’ 261 as shown in FIG. 2, the printing job generator 160 generates XHTML-Print data by describing a storage address of a selected image in the selected template. More specifically, as shown in FIG. 4A, the printing job generator 160 may generate printing data regarding the file for printing by describing a storage address of an image selected by the user within the XHTML-Print data.

Also, if the file for printing has been converted, the printing job generator 160 may update the address in which the file for printing is stored. More specifically, if the file for printing which has been converted by the converter 152 is stored in the storage unit 140 in a new name rather than being overwritten, the printing job generator 160 may update the address of the file for printing within the printing data so as to allow the converted file to be transmitted. For example, the storage address of the image described within the XHTML-Print data as shown in FIG. 4A may be updated into that shown in FIG. 4B.

A lookup table regarding an original file for printing and a converted file for printing may be prepared. In this case, if a request for transmission of a file for printing is received from the image forming apparatus 200, the control point 100 may transmit a converted file using the prepared lookup table without updating printing data.

Also, if a command to print is input by a user, the printing job generator 160 may control the user interface 130 to display a UI window to select a pre-stored template. The printing job generator 160 may generate printing data by applying the template and the printing option selected by the user.

The controller 170 controls the respective components of the control point 100. More specifically, if a command to print is input by a user through the communication interface 110, the controller 170 may control the user interface 130 to display a UI window to select an image forming apparatus for performing a printing operation. At this time, the controller 170 may control the user interface 130 to display a UI window to select a template and a printing option to be applied to a selected file for printing.

If a printing option and a template are selected by the user, the controller 170 may control the image processor 150 and the printing job generator 160 to convert the file for printing and generate printing data. The controller 170 may control the communication interface 110 to transmit the printing data generated by the printing job generator 160 and the file for printing converted by the image processor 150 to the selected image forming apparatus 200.

Also, the controller 170 may display an output form of the printing data in advance. More specifically, the controller 170 may control the user interface 130 to display a preview of an output form of generated printing data to allow the user to check how the file for printing is output in advance.

The controller 170 may store the generated printing data in the storage unit 140. More specifically, the controller 170 may store the printing data in the storage unit 140 in case a printing job for the same content is repeated. Therefore, if a command to print the same content is input afterward, the printing job can be performed rapidly using the pre-stored printing data. Also, the controller 170 may set the converted file for printing as shared contents within the DLNA network.

As described above, since the control point 100 converts the file for printing according to the size and format of an image to be output and then transmits the file to the image forming apparatus 200, a transmission load on the DLNA network can be mitigated.

The image forming apparatus 200 can access at least one control point 100 and may receive a request for device information from the control point 100. In response to the request, the image forming apparatus 200 may generate device information and transmit it to the control point 100. If the image forming apparatus 200 receives printing data and a file for printing from the control point 100, the image forming apparatus 200 prints the file based on the printing data. The image forming apparatus 200 may be a printer, a facsimile machine, a scanner, and a MFP incorporating the functions of the aforementioned devices in a single device.

More specifically, the image forming apparatus 200 may include a communication interface 210, a DLNA stack unit 220, a storage unit 230, an image forming unit 240, and a controller 250, as shown in FIG. 1.

The communication interface 210 is connected to a DLNA network and can share contents with the other control points 100, 20-1, 20-2, . . . within the DLNA network. More specifically, the communication interface 210 may communicate with the control points 100, 20-1, 20-2, . . . within the DLNA network according to the UPnP standard to be able to share contents stored in the control points 100, 20-1, 20-2, . . . .

Also, the communication interface 210 may receive a request for device information from the control point 100 and may transmit the device information to the control point 100. More specifically, the communication interface 210 may receive a request for device information from the control point 100, and may transmit the device information which is generated by the DLNA stack unit 220 or already generated and stored device information to the control point 100. The device information is information regarding performance of the image forming apparatus 200, and may include a current status of the image forming apparatus 200, a resolution, a paper size and information regarding ability/disability to perform a color printing operation of the image forming apparatus 200.

Also, the communication interface 210 may receive printing data from the control point 100. Also, the communication interface 210 may receive a file for printing which corresponds to the printing data from the control point 100.

The DLNA stack unit 220 may control the communication interface 210 to communicate with the control point 100 within the DLNA network according to the DLNA standard and the DLNA printer standard.

The DLNA stack unit 220 may generate device information of the image forming apparatus 200. More specifically, if a request for device information is received from the control point 100, the DLNA stack unit 220 may generate device information which includes a current status of the image forming apparatus 200, a resolution, a paper size, and information regarding ability/disability to perform a color printing operation of the image forming apparatus 200.

The DLNA stack unit 220 may control the communication interface 210 to transmit the generated device information to the control point which has transmitted the request for device information. The DLNA stack unit 220 may store the device information in the storage unit 230.

The storage unit 230 stores device information. More specifically, the storage unit 230 may store device information generated by the DLNA stack unit 220. Also, the storage unit 230 may store printing data and a file for printing which are received through the communication interface 210. The storage unit 230 may be an internal storage medium or an external storage medium of the image forming apparatus 200, for example, a removable disk including a USB memory.

The image forming unit 240 may perform printing with respect to the received printing data and file for printing. More specifically, the image forming unit 240 performs printing with respect to the file for printing received through the communication interface 210 according to settings of the printing data.

The controller 250 may control the respective components of the image forming apparatus 200. More specifically, if a request for device information is received from the control point 100, the controller 250 may control the DLNA stack unit 220 to generate device information and control the communication interface 210 to transmit the device information to the control point 100 which have transmitted the request for device information.

If a file for printing and printing data are received through the communication interface 210, the controller 250 may control the image forming unit to print the file for printing based on the printing data.

As described above, since the control point 100 of the printing control system 1000 converts the file for printing according to the device information received from the image forming apparatus 200 and then transmits the file to the image forming apparatus 200, a transmission load on the DLNA network can be mitigated. Table 1 shows transmission speed of a file for printing according to the present invention in comparison with a prior art.

TABLE 1

| Printing Condition | Prior Art | Present Invention |
|---|---|---|
| If one sheet is printed with 3,000,000 | 100 seconds | 100 seconds |
| pixels (output as an original file size), | | |
| If a template (2UP) is used for printing, | 80 seconds | 60 seconds |
| If a template (4UP) is used for printing, | 110 seconds | 80 seconds |

Referring to Table 1, if the image forming apparatus 200 prints a file as it is (that is, prints an original file as it is), the control point 100 is not required to perform image-processing and thus the time for transmitting the file is the same.

However, if a template is applied to the same image data (that is, if a 2-UP and a 4-UP are set), since the image forming apparatus 200 prints only some image of the original file, the file for printing according to an exemplary embodiment is transmitted with a reduced size. Therefore, the time for transmitting the file for printing is also reduced.

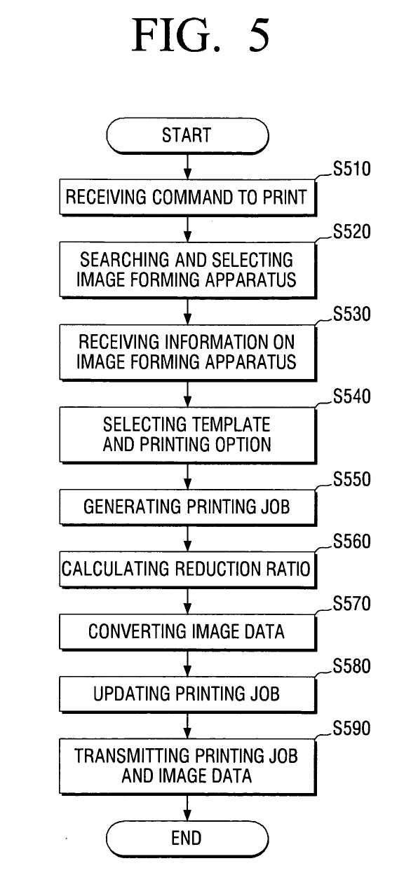

FIG. 5 is a flowchart illustrating a printing control method according to an exemplary embodiment of the present invention.

If a command to print a file for printing is received (S510), the control point 100 searches for an image forming apparatus which is connected to a DLNA network (S520). More specifically, if a command to print a file for printing is received from a user, the control point 100 may search for an image forming apparatus which is connected to the DLNA network to output the file for printing and displays the searched image forming apparatus for the user. Accordingly, the user selects one of the searched image forming apparatuses to output the file for printing. If the user selects one of the searched image forming apparatuses, the control point 100 may receive information on the selected image forming apparatus from the selected image forming apparatus (S530). The operation of receiving the information on the selected image forming apparatus may be performed in the operation of searching for an image forming apparatus. In this embodiment, the image forming apparatus is searched and selected when a command to print a file for printing is received from a user. However, the operation of searching and selecting an image forming apparatus may be performed before operation S510.

Then, at least one of pre-stored plural templates is selected or a printing option for the selected file for printing is selected (S540). More specifically, pre-stored plural templates are displayed for the user so that the user selects one template to apply to the file for printing. Also, a UI window to select a printing option for the file for printing is displayed so that the user selects a printing option for the file for printing. The template and the printing option may be pre-set as a default value. In this case, operation of selecting a template and a printing option by the user may be omitted.

Next, printing data regarding the file for printing is generated (S550). More specifically, XHTML-Print data including an address where the file for printing is stored is generated so that the file selected by the user can be output. For example, if the user selects a template 260 having ‘8-up layout’ 261 as shown in FIG. 2, XHTML-Print data (printing data) is generated by describing a storage address of an image selected by the user on the selected template. The printing data may be generated after the file for printing has been converted.

A reduction ratio of the file for printing is calculated using the received printing option (S560). More specifically, an ‘image size necessary for outputting a file for printing’ is calculated using a printing option regarding an image size and image quality among the selected printing options, and the calculated ‘image size necessary for outputting a file for printing’ is compared with the size of the selected file for printing, such that a reduction ratio is calculated. For example, if the selected file for printing has an image size of 7800(dot)*6000(dot) but if the ‘image size necessary for outputting a file for printing’, which is calculated based on the printing option selected by the user, is 1950(dot)*1500(dot) as shown in FIG. 3, 1500/6000=0.25, that is, the reduction ratio of the file is calculated as 25%.

The reduction ratio may be calculated additionally using the device information of the image forming apparatus 200. More specifically, the ‘image size necessary for outputting a file for printing’ may be calculated using resolution information of the device information supported by the image forming apparatus 200, and the reduction ratio is calculated based on this size information.

Also, the reduction ratio may be calculated additionally using size information of the selected template. More specifically, information of a size occupied by the file for printing within the selected template may be used as the ‘image size necessary for outputting a file for printing’. If the width/height ratio of the template selected by the user is different from the width/height ratio of the file for printing, a width reduction ratio and a height reduction ratio may be separately calculated. Also, one reduction ratio may be selected by the user or using a pre-set algorithm. Also, information of the width reduction ratio and the height reduction ratio may be provided in converting operation which will be described below.

Next, the file for printing is converted according to the calculated reduction ratio (S570). More specifically, the image size of the selected file for printing may be reduced according to the calculated reduction ratio. For example, if the calculated reduction ratio is 25%, the image size of the original file for printing is reduced by 25%. The image size may be reduced using diverse image processing algorithms.

In this operation, the selected file for printing may be converted into a monochrome image file. More specifically, if the selected image forming apparatus 200 does not support color printing or if a mono printing option is set by the user, the file for printing may be converted into a monochrome image.

Also, a file attribute of the file for printing may be converted such that data size of the file for printing is reduced. For example, if the file for printing has a file attribute of ‘bmp’, the file for printing may be converted into a ‘jpg’ file which is an example of a compressed image file.

In this case, the converted file may be stored. More specifically, the converted file may overwrite the original file for printing or may be stored in a pre-set name or a name selected by a user.

The generated printing data is updated (S580). More specifically, if the converted file is stored in a new name, the address of the file for printing within the printing data is updated so that the converted file is transmitted to the address. For example, the storage address of the file described in the XHTML-Print data as shown in FIG. 4A is updated into that shown in FIG. 4B. In this embodiment, the printing data is generated before the file for printing is converted and then the printing data is updated. However, the file for printing may be converted and then the printing data may be generated using the storage address of the converted file.

The generated printing data and the converted file are transmitted to the selected image forming apparatus 200 (S590). More specifically, the selected image forming apparatus 200 may be requested to perform a printing job according to the DLNA standard and the DLNA printer standard, and a job ID and a URL address (address to which the printing job is to be transmitted) for the corresponding printing job may be received from the image forming apparatus 200. The printing data may be transmitted to the received URL address, and if a request for the file for printing is received from the selected image forming apparatus 200, the converted file is transmitted.

According to the printing control method described above, since the file for printing is converted according to the image size and format of the file to be output and then transmitted to the image forming apparatus 200, a transmission load on the DLNA network can be mitigated. The printing control method of FIG. 5 may be executed in the control point 100 having the configuration of FIG. 1 and may be executed in a control point of any other configuration.

The foregoing exemplary embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A control point which is connected to at least one image forming apparatus under a digital living network alliance (DLNA) environment, the control point comprising:
a user interface through which at least one file for printing is selected;
a communication interface which searches for at least one image forming apparatus using DLNA;
a DLNA stack unit which receives device information corresponding to the searched at least one image forming apparatus;
an image processor which converts the file for printing to correspond to the image forming apparatus using the device information;
a printing job generator which generates printing data regarding the converted file for printing; and
a controller which controls the communication interface to transmit the generated printing data to the image forming apparatus.

2. The control point as claimed in claim 1, wherein the device information comprises at least one of a current status, a resolution, a paper size, and information regarding ability/disability to perform a color printing operation of the image forming apparatus.

3. The control point as claimed in claim 1, wherein the file for printing is at least one of an image file and a document file.

4. The control point as claimed in claim 1, wherein the user interface displays a list of the searched at least one image forming apparatus and receives selection of at least one image forming apparatus from the list, and
wherein the communication interface requests the selected image forming apparatus to transmit device information.

5. The control point as claimed in claim 1, wherein the printing job generator generates printing data by applying a printing option which is input through the user interface.

6. The control point as claimed in claim 5, wherein the image processor comprises:
a calculator which calculates a reduction ratio of the file for printing using the selected printing option; and
a converter which reduces an image size of the file for printing according to the calculated reduction ratio.

7. The control point as claimed in claim 1, wherein the image processor reduces or enlarges the file for printing according to the device information.

8. The control point as claimed in claim 1, wherein the image processor converts the file for printing into a monochrome or color image according to the device information.

9. The control point as claimed in claim 1, wherein the image processor converts a file attribute of the file for printing so as to reduce a data size of the file for printing.

10. The control point as claimed in claim 1, wherein the user interface receives selection of at least one template from pre-stored plural templates, and
wherein the image processor reduces an image size of the file for printing using size information of the selected template.

11. The control point as claimed in claim 1, further comprising a storage unit which stores the converted file for printing,
wherein the printing job generator changes an address of the file for printing within the generated printing data to an address of the converted file for printing.

12. An image forming apparatus which is connected to at least one control point under a digital living network alliance (DLNA) environment, the image forming apparatus comprising:
a DLNA stack unit to generate device information of the image forming apparatus;
a communication interface to transmit the generated device information to the control point; and
an image forming unit to print a received file for printing based on printing data corresponding to the generated device information.

13. A printing control method of a control point which is connected to at least one image forming apparatus under a digital living network alliance (DLNA) environment, the method comprising:
selecting at least one file for printing through a user interface of the control point;
searching for at least one image forming apparatus using DLNA;
receiving device information corresponding to the searched at least one image forming apparatus;
converting the file for printing to correspond to the image forming apparatus using the received device information;
generating printing data regarding the converted file for printing; and
transmitting the generated printing data to the image forming apparatus,
wherein the device information comprises at least one of a current status, a resolution, a paper size, and information regarding ability/disability to perform a color printing operation of the image forming apparatus.

14. The method as claimed in claim 13, wherein the file for printing is at least one of an image file and a document file.

15. The method as claimed in claim 13, further comprising:
displaying a list of the searched at least one image forming apparatus; and
selecting at least one image forming apparatus from the searched at least one image forming apparatus and requesting the selected image forming apparatus to transmit device information.

16. The method as claimed in claim 13, wherein the operation of generating the printing data generates the printing data by applying a printing option which is input through the user interface.

17. The method as claimed in claim 16, wherein the operation of converting the file for printing comprises:
calculating a reduction ratio of the file for printing using the selected printing option; and
reducing an image size of the file for printing according to the calculated reduction ratio.

18. The method as claimed in claim 13, wherein the operation of converting the file for printing reduces or enlarges the file for printing according to the device information.

19. The method as claimed in claim 13, wherein the operation of converting the file for printing converts the file for printing into a monochrome or color image according to the device information.

20. The method as claimed in claim 13, wherein the operation of converting the file for printing converts a file attribute of the file for printing so as to reduce a data size of the file for printing.

21. The method as claimed in claim 13, further comprising selecting at least one template from pre-stored plural templates,
wherein the operation of converting the file for printing reduces an image size of the file for printing using size information of the selected template.

22. The method as claimed in claim 13, further comprising:
storing the converted file for printing; and
changing an address of the file for printing within the generated printing data to an address of the converted file for printing.
